(19) United States
(12) Patent Application Publication
(10) Pub. No.: US 2022/0348328 A1
(43) Pub. Date: Nov. 3, 2022

(54) EMERGENCY RESPONSE DRONE

(71) Applicant: Gene Hunt, Chicago, IL (US)

(72) Inventor: Gene Hunt, Chicago, IL (US)

(21) Appl. No.: 17/305,469

(22) Filed: Jul. 8, 2021

Related U.S. Application Data
(63) Continuation-in-part of application No. 17/243,103, filed on Apr. 28, 2021.

(51) Int. Cl. B64D 1/18; A62C 3/02; G05D 1/10; G05D 1/00

(52) U.S. Cl. CPC B64D 1/18; A62C 3/0242; G05D 1/104; G05D 1/0094

(57) ABSTRACT

A firefighting aerial vessel that can coordinate with other firefighting aerial vessels to extinguish fires. The vessel has a body with a bottom container providing a volume for extinguishing substances that are fluidly coupled to spray units supported by the exterior of the body. The plurality of propulsion units of each vessel may be rotatably to the body of the vessel so that the vessel can move and rotate about the x, y, and/or z-axis. The vessel can form specific formation with other vessels in a coordinated manner by way of communication and positioning systems, so that the formation can surround and thwart fires.

### CROSS-REFERENCE TO RELATED APPLICATION

This application claims the benefit of priority of U.S. Non-provisional patent application Ser. No. 17/243,103, filed 28 Apr. 2021, as a continuation in part, the contents of which are herein incorporated by reference.

### BACKGROUND OF THE INVENTION

The present invention relates to systems and methods directed to emergency responses and situational awareness and, more particularly, a firefighting vessel embodied in a method and system for extinguishing fires.

Apparently due to climate change, wildfires are seemingly more common than ever and a critical threat to property and human lives in certain parts of the world. The quicker the response the better for everything and everybody involved as wildfires have a rapid forward rate of spread (FROS) when burning through dense uninterrupted fuels. They can move over six miles per hour (mph) in forests and 14 mph in grasslands. Wildfires can spread tangential to the main front to form a flanking front or burn in the opposite direction of the main front by backing. Wildfires may also advance by jumping or spotting as winds and vertical convection columns carry firebrands (hot wood embers) and other burning materials through the air over roads, rivers, and other barriers that may otherwise act as firebreaks. Torching and fires in tree canopies encourage spotting, and dry ground fuels around a wildfire are especially vulnerable to ignition from firebrands. Spotting can create spot fires as hot embers and firebrands ignite fuels downwind from the fire. Clearly, time is of the essence, which is why getting to the site of the wildfire where, for instance, small, controlled fires (sometimes referred to as a “counter fire” or a “back fire”) can be set in the path of a larger uncontrolled fire in order to limit the spread of the large fire by removing its fuel.

Unfortunately, getting personnel and their firefighting equipment to the fire site is the biggest obstacle to quickly responding to the dangers of wildfires, which can sometimes start in remote parts of a mountain or valley.

As can be seen, there is a need for a firefighting vessel embodied in a method and system for extinguishing fires adapted to respond to fires in a swarm or collective manner with other firefighting vessels, wherein each firefighting vessel can reach the fire site much faster than transporting human personnel over possibly rough terrain. The firefighting vessels of the present invention utilize a novel propulsion system and are configurable to coordinate their movements with other firefighting vessels.

Another deficiency of coordinating human personnel is obtaining and communicating situational awareness for the emergency response obscured by the smoke and blaze. As a corollary implementing a plan to extinguish the fire in a coordinated manner is yet another disadvantage of the human-personnel based approaches to thwarting the spread of wildfires.

Accordingly, the aerial vehicle of the present invention lends itself to the solution of the above-described problems, enabling information collection and thus situational awareness, as well as coordinating an aerial response above the smokescreen.

Again, response time is critical, and so the present invention has a novel propulsion system that includes a plurality of propulsion elements, wherein each may have a four-way tube fluidly coupled to high pressure elements to propel the vessel. These tubes afford individual jets to be fired selectively, individually or simultaneously. Moreover, the propulsions jets may be rotatably or pivotably connected to the body of the vessel so that pinpoint directed movement of the vessel is possible over 360-degrees about the x, y, and/or z axis.

The vessel can be electrically associated with other components of an overall emergency response system, such as a dispatcher system, emergency input and output devices (e.g., image capturing technology) and fire-related sensors. Furthermore, an onboard imaging device of the vessel may be controlled remotely by emergency responders or firefighting personnel. The vessel may have other scientific instruments that enable the capture and dissemination of emergency information and situational awareness.

The emergency drone embodied in the present invention is a sophisticated systemic component of an overall emergency response system that is connected to the thousands of emergency input, sensor, imaging, communication and global-positioning devices that can quickly reach a target area in unison and remain aloft for an extended amount of time as well as autonomously deliver a payload of fire-extinguishing substance that the vessels can autonomously retrievably replenish. Specifically, the present invention provides a system to control flying fire embers and/or producing back fires by selectively tilting a plurality of vessels at an angel of incidence relative to the fire in a circular formation or the like and coordinately delivering their payload.

### SUMMARY OF THE INVENTION

In one aspect of the present invention, a firefighting aerial vessel includes a body provide a plurality of propulsion units, each propulsion unit rotatably connected to the body in such a way that the body remains aloft or is movable and rotatable about an x-axis, y-axis, and z-axis in three-dimensional space; and a container engaging a lower portion of the body, wherein the container defines a volume fluidly connected to one or more spray units connected along an exterior of the body.

In another aspect of the present invention, the firefighting aerial vessel further includes a communication and positioning system configured to coordinate movement with other firefighting aerial vessels; and a compartment along an upper portion of the body, wherein the compartment is further defined by a protective cover, wherein the compartment is dimensioned and adapted to accommodate an adult human.

In yet another aspect of the present invention, a method for controlling a fire using a plurality of the above firefighting aerial vessels, the method including: filling each volume with a fire-extinguishing substance; coordinating the plurality of firefighting aerial vessels to encircle the fire in a circular formation; selectively urging the fire-extinguishing substance via one or more spray units at the fire; and refilling each volume by way of a replenishing tower providing reserve containers containing additional fire-extinguishing substance.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a side elevation view of an exemplary embodiment of the present invention;

FIG. 3 is a detailed perspective view of an exemplary embodiment of the present invention, illustrating independent rotational/pivotal connection of a propulsion element 20 and a body 12 of the vessel 10;

FIG. 4 is a schematic view of an exemplary embodiment of the present invention, illustrating replenishment of each vessel 10 by way of towers 14;

FIG. 5 is a perspective view of an exemplary embodiment of the present invention, illustrating an array formation 26;

FIG. 6 is a perspective view of an exemplary embodiment of the present invention, illustrating a circular formation 28;

FIG. 7 is a side elevation view of an exemplary embodiment of the present invention, illustrating how a vessel 10 can travel laterally, parallel with the surface, though it should be understood that the lift jets/propulsion elements 20 may be rotated clockwise ninety degrees to effectuate such a lateral movement;

FIG. 8 is an elevation view of an exemplary embodiment of the present invention;

FIG. 9 an elevation view of an exemplary embodiment of the present invention, directly to rescuing victims of fire, wherein the top cover 14 defines a compartment 16/dimensioned to accommodate an adult human; and

FIG. 10 is an elevation view of an exemplary embodiment of a body 12 of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

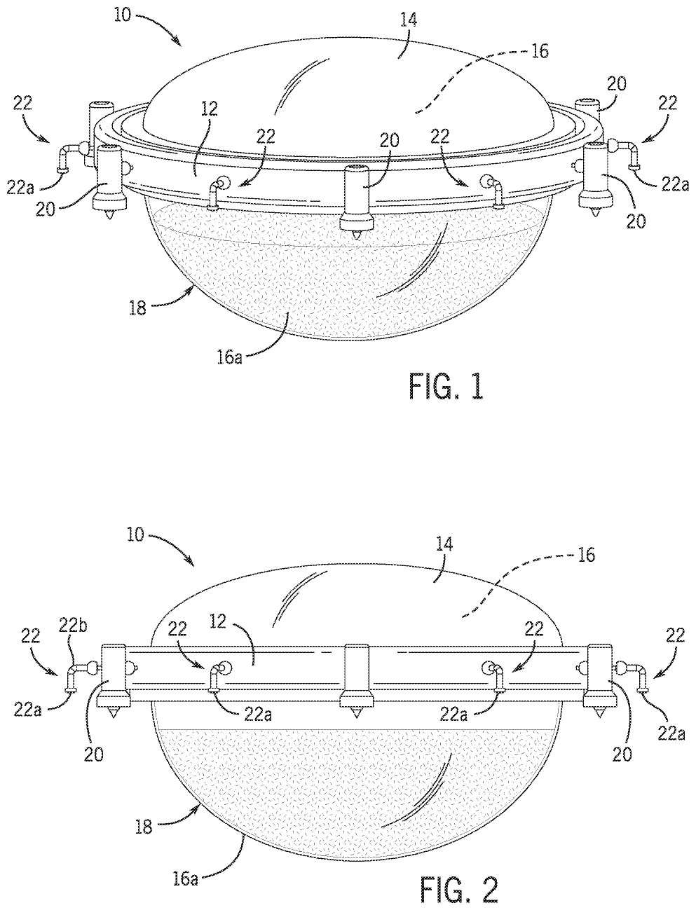

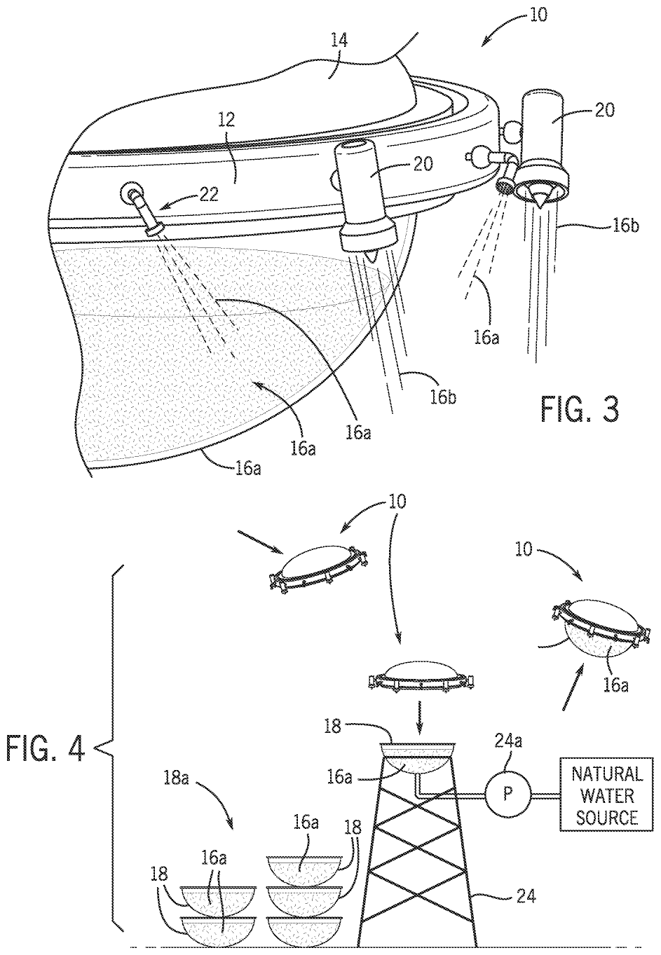

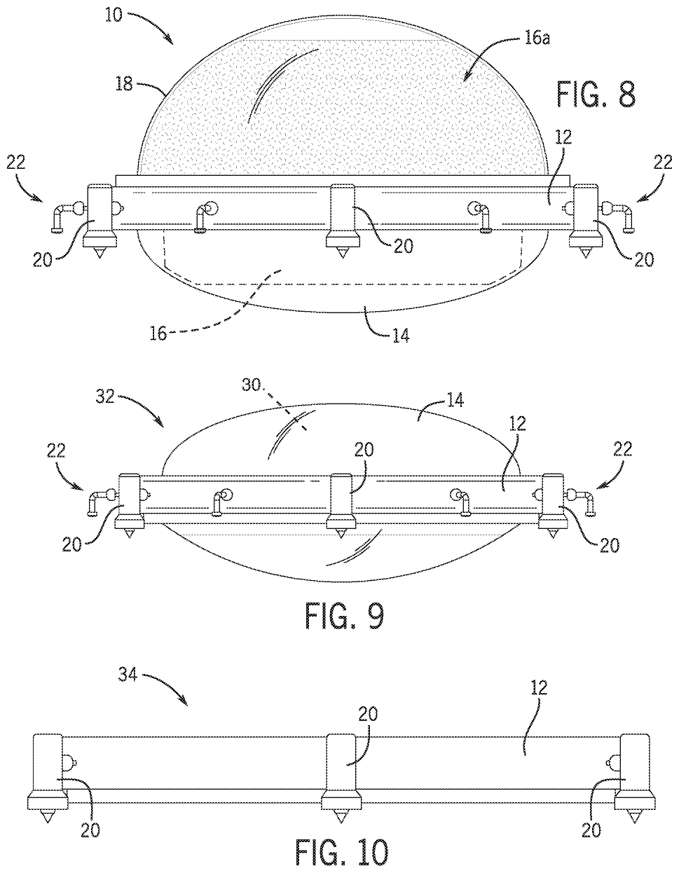

Referring now to FIGS. 1 through 10, the present invention may include a firefighting vessel 10/32 (or “drone”) having a propulsion system enabling the firefighting vessel 10/32 to cruise or stay afloat for a long period of time. The propulsion system may comprise a plurality of multidirectional propulsion elements 20. Each multidirectional propulsion element 20 may provide a four-way tube comprising a side thrust outlet, a top thrust outlet, and bottom thrust outlet for lateral, downward and upward thrust 16b, respectively. The remaining portal of the four-way tube may be operatively associated with a turbine for producing motive force. Each thrust outlet may have iris fins and operatively associated iris plate. The iris fins may operate as exhaust valves, controlling the direction of thrust 16b by selectively enabling or disabling thrust 16b through their respective outlet. The plurality of multidirectional propulsion elements 20 may be arranged in circular fashion that utilizes as few as possible to obtain the synergistic effect of “one to three” (e.g., one constructed with shutter/iris fin valves that allows that one to act as three: lateral, downward, and upward). The propulsion elements may rotate relative the body 12 so that the vessel 10/32 may pivot and/or rotate about the x, y, and/or z axis, and thus propel the vessel 10/32 in 360-degrees relative to the x, y, z axis, including moving vertically up and down, laterally to any side and/or tilt or spin relative to the supporting surface of a fire 26a.

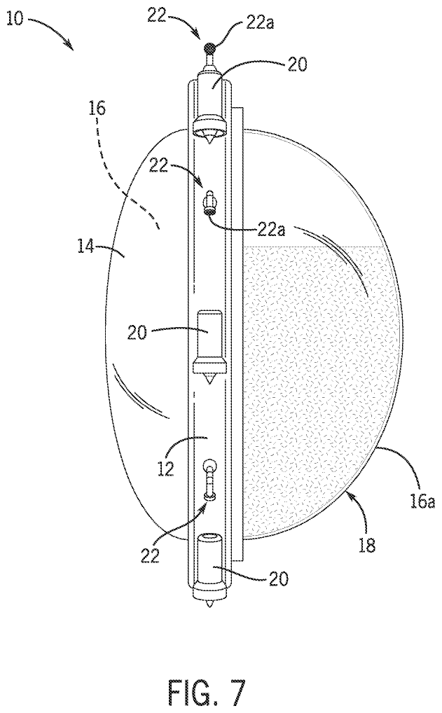

It should be understood by those skilled in the art that the use of directional terms such as side (lateral), top (upward), bottom (downward) and the like are used in relation to the illustrative embodiments as they are depicted in the figures. For instance, the downward direction being toward the bottom of FIGS. 6 and 7 the upward direction being toward the top of FIGS. 6 and 7, and lateral being toward the right and left sides of FIGS. 6 and 7.

The vessel 10/32 may be an unmanned aircraft having a body 12, with a top cover 14 removably attached to an upper portion of the body 12, and with a container 18 operatively associated with a lower portion of the body 12.

In certain embodiments 32, the body 12 and top cover 14 may be adapted to define a compartment 30 dimensioned to accommodate an adult human. The container 18 may be removably connected to a lower portion of the body 12 so as to define a volume for carrying an extinguishing substance 16a.

The body 12 may provide support for outward directed spray units 22 fluidly coupled to the volume. Each spray unit 22 may have an articulating portion 12b enabling the terminal end of the spray unit 22 to pivot, rotate, and/or move about the x, y, and/or z axis. The terminal end of each spray unit 22 may provide a spray nozzle 22a for selectively delivering the extinguishing substance 16a.

The compartment 16/30 (or space adjacent to the compartment 16) may also accommodate a computing device coupled to a form of memory, a plurality of control circuitry, a power source. The top cover 14 may provide solar cells electrically coupled to the power source. The firefighting vessel 10/32 may have data collection devices including, but are not limited to, smoke detector(s) (thereby enabling a smoke detection vessel 34), scent analyzer(s), timing device(s), infrared scanner(s), sonic sound detector(s), sound detector(s), motion sensor(s), microwave sensor(s), and visible light image capture device(s).

The computing device, memory and control circuitry includes at least one processor (e.g., a central processing unit (CPU), processor cores, compute nodes, etc.), a main memory and a static memory, which communicate with each other via a link (e.g., bus), defining a computer system. The computer system may further include a video display unit, an input device and a user interface (UI) navigation device. In one embodiment, the computer system may additionally include a storage device (e.g., a drive unit), a signal generation device (e.g., a speaker), a network interface device. The storage device includes a machine-readable medium on which is stored one or more sets of data structures and instructions (e.g., software) embodying or utilized by any one or more of the methodologies or functions described herein.

The computer system may be configured to respond to all available instruments owned and operated by an emergency response agency (e.g., a police department and their systemic components (e.g., “shot spotters”, cameras and the like). The computer system may use of the “cloud” to store and perform operations pre-designed to instantly get aloft and maneuver and operate (spontaneously).

The computer system enables electrically controlled steering (through selectively rotating and opening and closing the thrust valves) so that the vessel 10/32 can avoid obstacles and selectively deliver their payload as the propulsion elements 20 rotate about the x, y, and z axis.

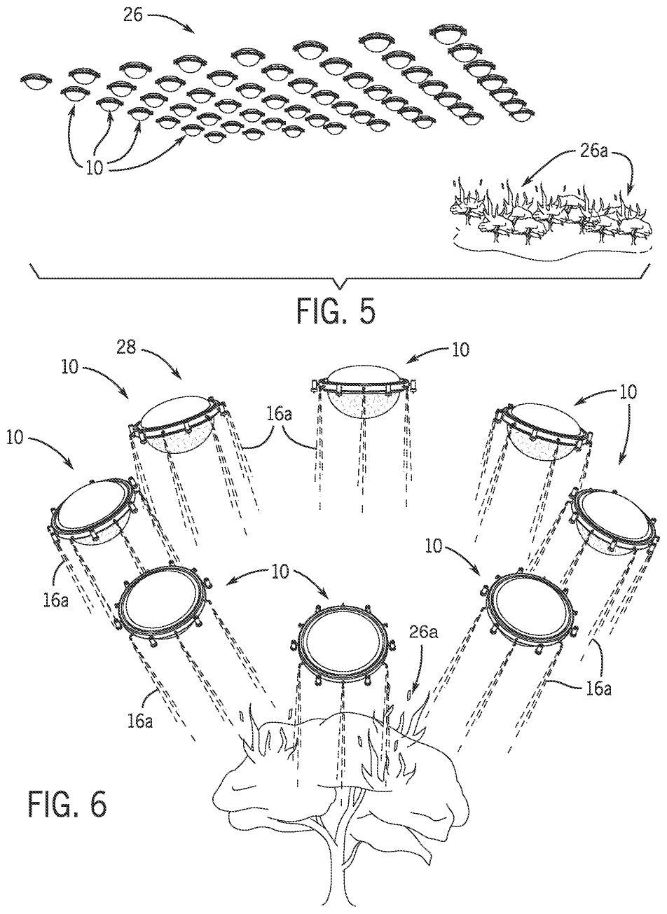

The computer system enables an operator of a plurality of vessels 10/32 to work in concert to move in rectilinear array formations 26 (see FIG. 5), circular formations 28 (see FIG. 6), or other formations so a to move between fire sites 26a or to replenishing towers 24. The replenishing towers 24 may support at least one reserve container 18a filled with the extinguishing substance 16a so that the vessel 10 need only land thereon so that the bottom portion of the body 12 engages and secures to the reserve container 18a through hooks or other connectors. The replenishing towers 24 may be fluidly coupled to a water source by way of a pump 24a. The replenishing towers 24 may have run off water supplied by the pump 24a drawing water from trenches at the foot of the towers 24.

In the circular formation 28, referring the FIG. 6, the plurality of firefighting vessels 10/32 may surround a fire 26a, thereby exhausting fuel by creating a fire break so that the fire 26a cannot further spread, while simultaneously preventing the spreading of embers, firebrands or other burning debris.

The various formations are engineered through each vessel 10/32 having communication and positioning systems to signal to other vessels 10/32 to indicate vectors, coordinates, and instructions for coordinating innumerable formations.

The size of the drone 10 can vary according to the tasks they are assigned to perform; for example, approximately five feet in diameter for fire detection vessels 34, while the firefighting vessels 10/32 may range between twenty to forty feet in diameter for carrying fire-extinguishing payload or for rescuing people via the compartment 16/30. It should be understood that the size of the vessel 10/32 can be more or less than defined immediately above, and the shape of the vessel 10/32 can be different that the disc-shape shown in the illustrations. In short, whatever size and shape enables the functionality disclosed herein is acceptable.

Some vessels 10/32 may have Asbestos, Pyrex. silicone tungsten sheets or other heat resistant material for warding off heat. Certain vessels 10/32 may fly directly into the fires 26a to save lives, as a survivor could jump into the compartment 30 when the top cover 14 is moved from a closed position to an open position an back.

A method of using the present invention may include the following. The emergency response drone 10/32 disclosed above may be provided. The operator may control the drone 10/32 remotely to move in any movement imaginable within three-dimensional space along a 360-degree coordinate system by selectively applying varying thrust 16b through the propulsions system 20 and valves. When at a fire site 26a the plurality of vessels 10/32 may selectively deliver their extinguishing substances through their spray units 22, in unison when organized in one of various formations. Thereafter a vessel 10/32 can replenish its volume/payload via the collection towers 24 described herein.

It should be understood, of course, that the foregoing relates to exemplary embodiments of the invention and that modifications may be made without departing from the spirit and scope of the invention as set forth in the following claims.

What is claimed is:

1. A firefighting aerial vessel, comprising:
a body provide a plurality of propulsion units, each propulsion unit rotatably connected to the body in such a way that the body remains aloft or is movable and rotatable about an x-axis, y-axis, and z-axis in three-dimensional space; and
a container engaging a lower portion of the body, wherein the container defines a volume fluidly connected to one or more spray units connected along an exterior of the body.

2. The firefighting aerial vessel of claim 1, further comprising a communication and positioning system configured to coordinate movement with other firefighting area vessels.

3. The firefighting aerial vessel of claim 2, further comprising a compartment along an upper portion of the body, wherein the compartment is further defined by a protective cover.

4. The firefighting aerial vessel of claim 3, wherein the compartment is dimensioned and adapted to accommodate an adult human.

5. A method for controlling a fire using a plurality of firefighting aerial vessels of claim 2, the method comprising:
filling each volume with a fire-extinguishing substance;
coordinating the plurality of firefighting aerial vessels to encircle the fire in a circular formation; and
selectively urging the fire-extinguishing substance via one or more spray units at the fire.

6. The method of claim 5, further comprising refilling each volume by way of a replenishing tower providing reserve containers containing additional fire-extinguishing substance.
